(19) United States
(12) Patent Application Publication
(10) Pub. No.: US 2025/0083187 A1
(43) Pub. Date: Mar. 13, 2025

(54) METHOD FOR CONTROLLING AN ULTRASONIC GENERATOR, AND ULTRASONIC GENERATOR

(71) Applicant: SCHUNK SONOSYSTEMS GMBH, Wettenberg (DE)

(72) Inventors: Kevin RUMRICH, Solms (DE); Steve SCHONER, Leun-Biskirchen (DE); Valentin MUELA, Solms (DE)

(73) Assignee: SCHUNK SONOSYSTEMS GMBH, Wettenberg (DE)

(21) Appl. No.: 18/728,970

(22) PCT Filed: Mar. 22, 2022
(86) PCT No.: PCT/EP2022/057448

§ 371 Date: Jul. 15, 2024

(51) Int. Cl. B06B 1/02

(52) U.S. Cl. CPC B06B 1/0253; B06B 2201/40; B06B 2201/55

(57) ABSTRACT

An ultrasonic generator and a method for controlling an oscillator unit (13) of the ultrasonic generator (10) in a machine tool for generation of ultrasound to excite a tool (26). A control variable for controlling a frequency f of an electrical control signal HFS generated by the oscillator unit (13) is determined depending on an analysis of the size of an input and/or output current I or of an input and/or output power P of the ultrasonic generator (10).

The invention relates to a method for controlling an oscillator unit of an ultrasonic generator in a machine tool for the generation of ultrasound to excite a tool for machining a workpiece, wherein a control variable is determined for controlling a frequency f of an electrical control signal generated by the oscillator unit.

The invention further relates to an ultrasonic generator in a machine tool for the generation of ultrasound to excite a tool for machining a workpiece, comprising an oscillator unit designed to emit an electrical control signal for generation of the ultrasound, and a control unit designed to determine a control variable for controlling a frequency f of the electrical control signal generated by the oscillator unit.

A corresponding method and a system for controlling an ultrasonic generator of a machine tool for machining a workpiece is known from DE 10 2020 201 540 A1. With this method, electrical signals with differing frequencies are generated for machining a workpiece, wherein the frequencies are in the frequency range of ultrasound. Ultrasonic waves that are transmitted to a tool are generated by means of the electrical signals. A phase shift of the electrical signals depending on the frequency is then determined as a regulating variable, and said phase shift is analyzed depending on the frequency. Finally, a regulation algorithm for controlling the frequency of the ultrasound generated by the ultrasonic generator is determined depending on the analysis of the phase shift. Determination and analysis of the phase shift as a regulating variable is complex. The voltage and current curves of the electrical signals must be evaluated simultaneously to one another.

A further method for controlling an ultrasonic generator is known from DE 10 2016 214 699 A1. In this method, a ceramic sensor is additionally needed on the tool.

Based on this, the object underlying the present invention is to develop a method for controlling an ultrasonic generator of a machine tool of the type mentioned at the outset such that the vibration of the tool is settable in easy manner and in particular a precise and reproducible amplitude deflection of the tool is settable.

This object is solved in accordance with the invention partly in that the control variable is determined depending on an analysis of the size/amplitude of an input and/or output current I or of an input and/or output power P of the ultrasonic generator. The invention is based on the idea of readjusting the vibration of the system, preferably exclusively using the current continuously recorded in operation, in particular the input current Iein or the resultant power Pzu.

Preferably, the electrical control signal HFS generated by the oscillator unit is amplified by an amplifier unit of the ultrasonic generator, wherein the analysis of the size/amplitude of the input and/or output current I comprises a comparison of the size/amplitude of an input and/or output current Iein of the amplifier circuit with a setpoint current value Isoll.

In a particularly preferred procedure, it is provided that the setpoint current value Isoll is determined by the tool being scanned prior to machining by means of the ultrasonic generator and by the oscillator unit exciting the tool during a frequency sweep in a definable frequency band with differing frequencies f, wherein the input current Iein or the input power Pein of the amplifier unit is recorded during the frequency sweep over the frequency f and, based on the current curve, a maximum current Imax or a maximum power Pmax is determined as a setpoint value at a resonance point RS and an associated resonance frequency fres and saved.

Machining of the workpiece with the saved resonance frequency fres may then be started.

Furthermore, it is proposed in accordance with the invention that the input current Iein or the input power Pein of the amplifier unit is measured during machining of the workpiece, that the size of the input current Iein as the actual current value is continuously compared with the maximum current Imax as the setpoint current value (reference variable), and that the control variable for the oscillator unit (setting device) is determined depending on a divergence (regulation difference) between the actual current value and the maximum current Imax, wherein the frequency f as the setting variable for the oscillator unit (setting device) is changed by means of the control variable such that the input current Iein reaches or approaches the maximum current Imax. The method offers the advantage that it is exclusively the input current Iein that has to be measured and that the current curve may be obtained in simple manner. Also, the control variable may be determined as a divergence between the input current and the maximum current at the resonance point using simple means.

It must be particularly emphasized that in the event of a change in the frequency f of the oscillator unit, a reaction of the input current Iein is analyzed, wherein when the input current Iein rises in the event of a change in the frequency f, the frequency f is changed in the same direction as that change until the input current reaches the maximum current Imax, and wherein whenever the input current I falls in the event of a change in the frequency f, the frequency f is changed in the opposite direction to that change until the input current Iein reaches the maximum current Imax. Rapid regulation is achieved by that method.

An independently inventive idea is characterized in that an amplitude deflection AMP of the tool is set using the size of the input current Iein. The size of the input current Iein is set here using the setting of the frequency f of the oscillator, wherein the frequency is higher or lower than the resonance frequency fres.

The invention further relates to an ultrasonic generator in a machine tool for generation of ultrasound to excite a tool for machining a workpiece. The ultrasonic generator comprises an oscillator unit designed to emit an electrical control signal HFS with a frequency f for generation of the ultrasound, and a control unit designed to determine a control variable for controlling the frequency f of the electrical control signal HFS generated by the oscillator unit.

In accordance with the invention, it is provided that the control unit is designed to determine the control variable preferably exclusively depending on an analysis of the size/amplitude of the input and/or output current I or of the size/amplitude of the input and/or output power P of the ultrasonic generator (10).

The ultrasonic generator preferably comprises an amplifier unit designed to amplify the electrical control signal HFS generated by the oscillator unit, wherein the ultrasonic generator has a current sensor designed to measure the input current Iein of the amplifier unit, and wherein the control unit has a comparator unit designed to compare the input current Iein with a setpoint current value Isoll, preferably a resonance current Ires, and to provide it as a regulation difference, and wherein the control unit has a regulator unit designed to determine the control variable depending on the regulation difference between the input current Iein and the setpoint current value Isoll.

Particularly preferably, an energy transmitter, for example an induction transmitter, a cable connection or a slip ring transmitter, is connected to an output of the amplifier unit, wherein the energy transmitter is connected to a piezo system which converts a high-frequency electrical output signal HF present at an output of the amplifier unit into ultrasonic vibration, and wherein the piezo system is coupled to the tool for transmitting the ultrasonic vibration to the tool.

Further details, advantages and features of the invention can be gathered not only from the claims and from the features to be found therein, singly and/or in combination, but also from the following description of preferred examples to be found in the description of the drawing.

The drawing shows in:

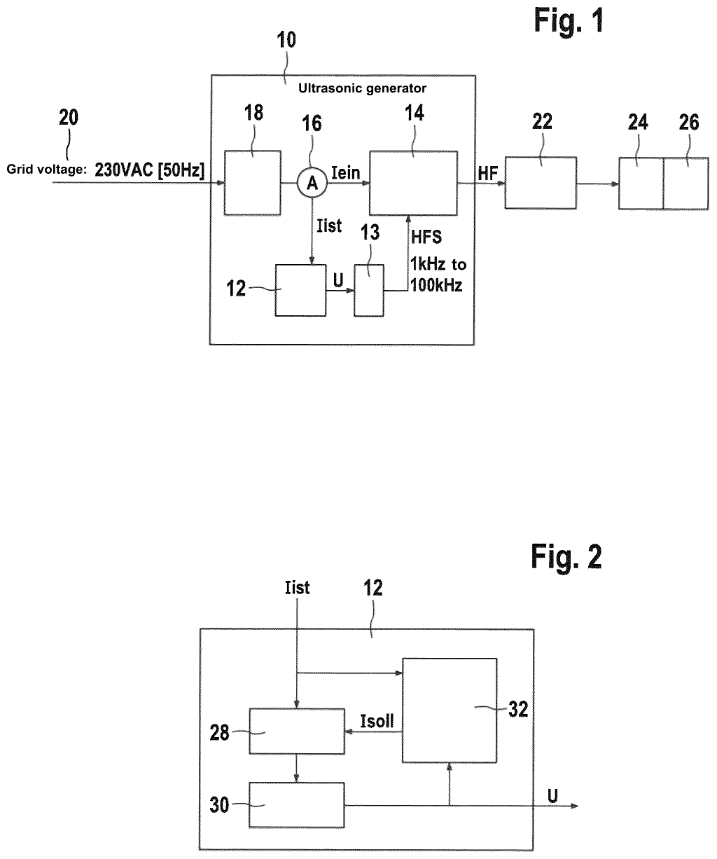

FIG. 1 a block diagram of an ultrasonic generator for generation of ultrasound to excite a tool,

FIG. 2 a block diagram of a generator unit and control unit,

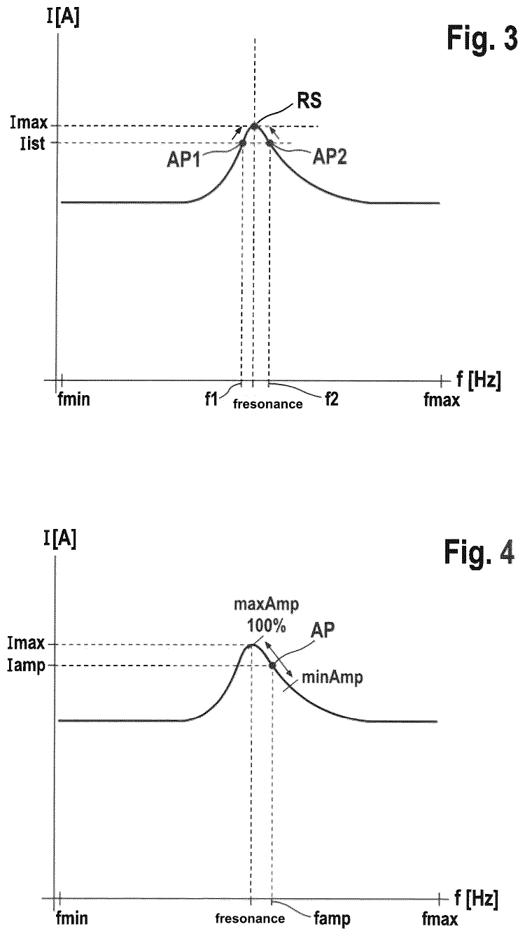

FIG. 3 a curve of an input current of an amplifier unit of the ultrasonic generator as a regulating variable over the frequency as a setting variable for setting an optimum operating point, and

FIG. 4 a curve of an input current of an amplifier unit of the ultrasonic generator as a regulating variable over the frequency as a setting variable for setting an operating point with predetermined vibration amplitude.

FIG. 1 shows a block diagram of an ultrasonic generator 10, comprising a control unit 12, an oscillator unit 13, an amplifier unit 14, a sensor unit such as a current sensor 16, and a voltage supply 18 connected on the input side to grid voltage 20.

An energy transmitter 22, for example an induction transmitter or alternatively a cable connection or a slip ring transmitter, is connected to an output of the amplifier unit 14 where a high-frequency electrical output signal HF is present for operating a piezo system 24. The piezo system 24, which generates an ultrasonic vibration from the high-frequency electrical output signal HF, is coupled to a tool 26 or to a tool holder (not shown) receiving the tool 26, to couple the ultrasonic vibration into the tool 26 such that it said tool performs the required ultrasonic vibration. A frequency and an amplitude of the ultrasonic vibration are settable by a frequency f and by an amplitude of the high-frequency electrical output signal HF.

It is known from the literature that by coupling ultrasonic vibration into the tool 12, a machining process such as grinding or metal-cutting machining is assisted: this is because ultrasonic vibration generates an oscillation of the tool, which generates movement amplitudes in the range of a few micrometers at a contact between tool and workpiece, from which amplitudes a reduction of the process forces results. The ultrasound may be introduced into the tool longitudinally and/or transversely.

The idea underlying the invention is to regulate the frequency and/or amplitude of the ultrasonic vibration of the tool 26 based on the size of an input current Iein or of an input power Pein of the amplifier unit 14. In particular, improved amplitude regulation is to be provided regardless of the damping of the system. Regulation of the input current I is performed using the control unit 12.

FIG. 2 shows a block diagram of the control unit 12 designed in the form of a microcontroller. The control unit 12 comprises a comparator unit 28, a regulator unit 30, and a computing and storage unit 32. The input current Iein of the amplifier unit 14 is measured by means of the current sensor 16 and is supplied to the comparator unit 28 and to the computing and storage unit 32 as an actual current value list. A setpoint current value Isoll is provided by the computing and storage unit 32 and supplied to the comparator unit 28. An output of the comparator unit 28 is connected to an input of the regulator unit 30. The regulator unit 30 generates a control variable with which the frequency f of a high-frequency electrical control signal HFS of the oscillator unit 13 is settable. The control variable present at the output of the regulator unit 30 and proportional to the frequency f of the high-frequency control signal HFS is provided to the storage unit 32. Regardless of the frequency f, an amplitude of the high-frequency control signal HFS which is substantially proportional to the amplitude deflection of the tool 26 may also be set.

The high-frequency electrical control signal HFS is connected to an input of the amplifier circuit 14 and is amplified by the latter. The amplified high-frequency electrical output signal HF is present at the output of the amplifier circuit 14 to excite the piezo system 24.

In accordance with the invention, the following procedure is performed.

Since the efficiency of workpiece machining due to superimposition of an ultrasonic vibration depends in particular on the geometry of the tool used and on its clamping length, the tool 26 is scanned in a first step by means of a frequency sweep of the ultrasonic generator 10. The frequency sweep, i.e. scan, is performed in a selected and defined frequency band which is defined by a minimum frequency of the control signal HFS of e.g. fmin=1 kHz and by a maximum frequency of e.g. fmax=100 kHz. The oscillator unit 13 is designed to generate the high-frequency control signal HFS in a further frequency band of for example fmin=1 KHz to fmax=100 kHz. During the frequency sweep, the input current Iein of the amplifier circuit 14, and the control variable present at the output of the regulator unit 30 and proportional to the frequency f of the oscillator unit 13, are recorded and saved in the computing and storage unit 32, to permit recording of a curve of the input current Iein over the frequency f.

FIG. 3 shows the curve of the input current Iein recorded during the frequency sweep over the frequency f of the high-frequency control signal HFS, wherein the frequency f of the high-frequency control signal HFS corresponds to the frequency f of the ultrasonic vibration. Based on the recorded input current Iein, in a second step a resonance point RS is determined in the computing and storage unit 32 for the system made up of the energy transmitter 22, the piezo system 24 and the tool 26. In the resonance point RS, the input current Iein shows its maximum value Imax (maximum). The maximum value Imax is saved. The frequency f at the point of the maximum value Imax, i.e. at the resonance point RS, is saved in the computing and storage unit 32 as the resonance frequency fres.

After determination of the resonance frequency fres, machining of the workpiece using the tool 26 may start in a third step.

During operation of the tool 26, the input current Iein is continuously measured using the current sensor 16. Using the input current Iein continuously recorded in operation, the frequency f of the oscillator unit 13, and hence the frequency f of the amplified high-frequency output signal HF, is readjusted in a fourth step.

The measured input current Iein as the actual current value and the maximum value Imax of the input current are supplied as input variables to the comparator unit 28. In the comparator unit 28, the measured input current Iein as the actual current value is compared with the maximum value Imax as the setpoint current value. If the measured input current Iein falls below the setpoint current value Imax from the frequency sweep, e.g. 10% below Imax, a regulation divergence is present at the output of the comparator unit 28, which is supplied to the regulator unit 30. Depending on the regulation divergence, a control variable is generated at the output of the regulator unit 30, with which variable the oscillator unit 13 is operated for setting the frequency f of the high-frequency control signal HFS. The frequency f of the high-frequency control signal HFS is a setting variable for a regulating section formed by the amplifier unit 14, the energy transmitter 22, the piezo system 24 and the workpiece 26.

Accordingly, controlling the frequency f of the oscillator unit 13 also sets the frequency of the high-frequency output signal HF for operating the energy transmitter 22 with piezo system 24 and tool 26 as the regulating section, such that the input current Iein reaches its maximum value Imax.

FIG. 3 shows that the system may, in the case of a measured input current Iein which is smaller than the maximum value Ima, be located either at an operating point AP1 where f1<fres or at an operating point AP2 where f2>fres. For determining the operating point AP1 or AP2, the oscillator unit 13 is operated by the setting variable such that the frequency of the oscillator unit 13 is increased or reduced in increments of, for example, 1 Hz, 10 Hz or 100 Hz. At the same time, the behavior of the input current list is analyzed. If the input current Iist increases when the frequency f is increased, the system is at the operating point AP1, and the frequency f is increased until the input current list reaches the maximum value Imax. If the input current list however drops when the frequency f is increased, the system is at the operating point AP2, such that the frequency f is reduced until the input current list reaches the maximum value Imax.

Accordingly, the idea underlying the method is to readjust the system using the input current list continuously recorded in operation, wherein when the current value Imax from the frequency sweep (+/−tolerance) is not attained, the system is driven back to its maximum current Imax by a slight change (+/−) in the frequency f and analysis of the resultant behavior (reaction) of the input current Iist.

In other words, the current sensor 16 as the measuring device, the comparator unit 28 as the comparator, the regulator unit 30 as the regulator, the oscillator unit 13 as the setting device and the amplifier circuit 14 with energy transmitter 24, piezo system 15 and tool 26, form a regulating circuit as a regulating section, wherein the input current list as the regulating variable is readjusted during operation such that it reaches its maximum value Imax and the system is effectively operated in the resonance point RS.

With the method in accordance with the invention, there is also the possibility of controlling an amplitude deflection Amp of the tool 26 using the supplied input current Iist.

FIG. 4 shows the input current list over the frequency f of the high-frequency signal HF. By changing the frequency f, e.g. to a frequency value famp, the input current list may be set to a current value lamp such that the system is at a required operating point AP with a required amplitude Amp of the tool 26. By changing the frequency f, the operating point AP may be shifted on the curve of the input current list in the direction of the arrows shown, i.e. rising or falling on the curve. Shifting of the operating point AP on the current curve corresponds to a change in the amplitude deflection or vibration amplitude of the tool 26. By moving the operating point AP of the system on the approximately straight partial section of the current curve with a constant gradient, the vibration amplitude may be set between a maximum amplitude maxAmp and a minimum amplitude minAmp. In other words, amplitude regulation is achieved based on the input current list.

1. A method for controlling an oscillator unit (13) of an ultrasonic generator (10) in a machine tool for the generation of ultrasound to excite a tool (26) for machining a workpiece, wherein a control variable is determined for controlling a frequency f of an electrical control signal generated by the oscillator unit (13),
characterized in that the control variable is determined depending on an analysis of the size of an input and/or output current I or of an input and/or output power P of the ultrasonic generator (10).

2. The method according to claim 1,
characterized in that the control variable is determined exclusively depending on analysis of the input and/or output current I or of the input and/or output power P.

3. The method according to claim 1,
characterized in that the electrical control signal HFS is amplified by an amplifier unit (14) of the ultrasonic generator (10) and that the analysis of the size of the input and/or output current I comprises a comparison of the size/amplitude of an input and/or output current Iein of the amplifier unit (14) with a setpoint current value Isoll.

4. The method according to claim 1,
characterized in that the setpoint current value Isoll is determined by the tool (26) being scanned prior to performing machining by means of the ultrasonic generator (10) and by the oscillator unit (13) exciting the tool (26) during a frequency sweep in a definable frequency band with differing frequencies f, wherein the input current Iein or the input power Pein of the amplifier unit (14) is recorded during the frequency sweep over the frequency f and, based on the current curve, a maximum current Imax is determined as a setpoint current value at a resonance point RS and an associated resonance frequency fres and saved.

5. The method according to claim 1,
characterized in that machining of the workpiece (26) with the saved resonance frequency fres is started.

6. The method according to claim 1,
characterized in that the input current Iein or the input power Pein of the amplifier unit (14) is measured during machining of the workpiece (26), that the size/amplitude of the input current Iein as the actual current value Iist is continuously compared with the maximum current Imax as the setpoint current value Isoll and that depending on a divergence between the actual current value Iist and the maximum current Imax the control variable is determined by means of which the frequency f of the oscillator unit (13) is changed such that the actual current value Iist reaches or approaches the maximum current Imax.

7. The method according to claim 1,
characterized in that in the event of a change in the frequency f of the oscillator unit (13), a reaction of the input current Iein is analyzed, wherein when the input current Iein rises in the event of a change in the frequency f, the frequency f is further changed in the same direction as that change until the input current Iein reaches the maximum current Imax, and wherein whenever the input current Iein falls in the event of a change in the frequency f, the frequency f is changed in the opposite direction to that change until the input current Iein reaches the maximum current Imax.

8. The method according to claim 1,
characterized in that an amplitude deflection AMP of the tool (26) is set using the size of the input current Iein.

9. The method according to claim 1,
characterized in that the size of the input current Iein is set using the setting of the frequency f of the oscillator unit (13), wherein the frequency is higher or lower than the resonance frequency fres.

10. An ultrasonic generator (10) in a machine tool for generation of ultrasound to excite a tool (26) for machining a workpiece, comprising:
an oscillator unit (13) designed to emit an electrical control signal HFS with a frequency f for generation of the ultrasound,
a control unit (12) designed to determine a control variable for controlling the frequency f of the electrical control signal HFS generated by the oscillator unit (13),
characterized in that the control unit (12) is designed to determine the control variable depending on an analysis of the size/amplitude of the input and/or output current I or of a size/amplitude of the input and/or output power P of the ultrasonic generator (10).

11. The ultrasonic generator according to claim 10,
characterized in that the ultrasonic generator (10) has an amplifier unit (14) designed to amplify the electrical control signal HFS generated by the oscillator unit (13),
that the ultrasonic generator (10) has a current sensor (16) designed to measure the input current Iein of the amplifier unit (14),
that the control unit (12) has a comparator unit (28), designed to compare the input current Iein with a setpoint current value Isoll, preferably a resonance current Ires, and to provide it as a regulation difference, and
that the control unit (12) has a regulator unit (30) designed to determine the control variable depending on the regulation difference between input current Iein and setpoint current Isoll.

12. The ultrasonic generator according to claim 10,
characterized in that an energy transmitter (22), for example an induction transmitter, a cable connection or a slip ring transmitter, is connected to an output of the amplifier unit (14), that the energy transmitter (22) is connected to a piezo system (24) which converts a high-frequency electrical output signal HF present at an output of the amplifier unit (14) into ultrasonic vibration, and that the piezo system (24) is coupled to the tool (26) for transmitting the ultrasonic vibration to the tool.
